(19) United States
(12) Patent Application Publication
(10) Pub. No.: US 2017/0179782 A1
(43) Pub. Date: Jun. 22, 2017

(54) ELECTRIC MOTOR HAVING WAVE-WINDING COIL AND MANUFACTURING METHOD THEREOF

(71) Applicant: FANUC CORPORATION, Yamanashi (JP)

(72) Inventor: Takashi Ito, Yamanashi (JP)

(73) Assignee: FANUC CORPORATION, Yamanashi (JP)

(21) Appl. No.: 15/380,185

(22) Filed: Dec. 15, 2016

(30) Foreign Application Priority Data
Dec. 22, 2015 (JP) 2015-249957

(51) Int. Cl. H02K 3/28; H02K 15/06; H02K 3/12

(52) U.S. Cl. CPC H02K 3/28; H02K 3/12; H02K 15/066

(57) ABSTRACT

An electric motor having a stator, in which the number of coils and the number of jumper wires between the coils are reduced, and a method for manufacturing the electric motor. An 8-shaped coil is formed by twisting a portion of one annular coil, and then the coil is inserted and positioned in three slots. A first coil portion of the 8-shaped coil including two overlapped edges is inserted into the center slot, and other two edges, i.e., second coil portions positioned opposed to the first coil portion in the circumference direction of the stator with respect to each ring constituting the 8-shape, are respectively inserted into the slots at the both side of the center slot, in which each second coil portion does not include overlapped winding wires.

### BACKGROUND OF THE INVENTION

1. Field of the Invention

The present invention relates to an electric motor having a wave-winding coil with an 8-shape, and relates to a method for manufacturing the coil.

2. Description of the Related Art

In an electric motor having a permanent magnet, pulsation referred to as “cogging torque” and/or torque fluctuation referred to as “torque ripple” may occur. In the prior art, as a combination of the number of poles and the number of slots capable of reducing the cogging torque and the torque ripple, an electric motor having a fractional slot may be used, in which the number of slots divided by the number of poles corresponds to an irreducible fraction (for example, see JP 2004-023950 A).

On the other hand, various methods or devices, for winding or inserting a coil in a slot formed on a stator of an electric motor, have been proposed. For example, JP 2011-030309 A discloses a stator of an electric motor having twelve slots, ten poles and single Y-connection, wherein a coil can be easily formed on a band-like stator core on which an insulating part is formed, so that jumper wires of different phases do not contact each other.

Further, JP 2015-126661 A discloses a winding insertion machine, wherein a plurality of coils is aligned on a coil set base corresponding to blades of an inserter tool so that all of the coils can be positioned at one time, and then the coils on the inserter tool can be inserted into slots of a stator by one operation.

In an electric motor having a fractional slot, in which the number of slots divided by the number of poles corresponds to an irreducible fraction, the number of slots and the number of poles can be selected so that a lowest common multiple (LCM) between the number of slots and the number of poles is maximized. Further, since a high-order value of a distributed winding coefficient can be decreased, the cogging torque and torque ripple can be reduced in the electric motor having the fractional slot. For example, in an electric motor in which number of slots 6N is larger than one and a half times of the number of pole pairs P and is not more than three times the number of pole pairs P (1.5P<6N<3P), a concentrated winding motor (in which a slot pitch is one) can be constituted. In this case, since one coil can be wound in neighboring slots, the coil can be directly wound on a tooth part of a stator by using a nozzle of a winding machine. This is very advantageous as a method for manufacturing the electric motor.

In another method, a coil is previously wound on a bobbin manufactured from an insulating material so as to be inserted into a slot, and the bobbin having the wound coil is inserted into the slot. Although the man-hours required for production can be reduced by utilizing such a concentrated winding process, there are limitations to the reduction of the man-hours, since the coils must be sequentially formed one-by-one.

On the other hand, an electric motor in which number of slots 6N is larger than three times of the number of pole pairs P (6N>3P) has high characteristics, since the cogging torque and torque ripple can be significantly reduced in such a motor relative to the concentrated winding electric motor having the fractional slot. However, in such a motor, the coil can be formed by a distributed winding process only, since the coil pitch of the winding inserted into the slot is larger than one. In particular, in an electric motor, in which the number of slots divided by the number of poles corresponds to an irreducible fraction and a denominator of the fraction is four or more, the arrangement of the windings becomes complicated. Therefore, the number of coils to be inserted into the slots is increased, and it is difficult to automatize a winding operation in the manufacturing process. Further, the number of jumper wires connected between the coils is also increased with an increase in the number of the coils, and thus the winding wires may be intricately intertwined with each other.

On the other hand, in an automated winding machine having an inserter, a nozzle or a flyer of the winding machine is rotated about a winding frame so as to manufacture coils one-by-one, the manufactured coils are inserted into the inserter, and the inserter is gradually inserted into a stator so as to wind the coils on the stator. In such a process, the number of times of inserting the coils into the inserter is increased as the number of coils to be manufactured is increased, and thus many man-hours for production are necessary. Further, since many coils are inserted into the inserter, the winding wires are intricately intertwined with each other when the number of jumper wires between the coils is relatively large, whereby a defect in a product may occur.

As described above, although high-performance can be obtained by the electric motor having the fractional slot with the complicated winding arrangement, the number of the coils is large, whereby the man-hour of the manufacturing process is increased. Further, since the number of the jumper wires is also large, the jumper wires may be intricately intertwined with each other.

### SUMMARY OF THE INVENTION

Thus, the object of the present invention is to provide an electric motor having a stator, in which the number of coils and the number of jumper wires between the coils are reduced, and to provide a method for manufacturing the electric motor.

Therefore, one aspect of the present invention provides a three-phase alternating-current motor, comprising: a rotor having a plurality of pairs of poles; a stator positioned opposed to the rotor in a radial direction, the stator having a plurality of slots aligned in a circumference direction and extending in a rotational direction of the rotor; and a plurality of winding wires inserted into the slots and wound on the stator, wherein the rotor has P pairs of poles and 6N slots where the winding wires of the stator are inserted, the number of slots 6N divided by the number of pairs of poles P corresponds to an irreducible fraction, and a denominator of the fraction is two or more; wherein the winding wires are positioned in the slots so that the winding wires are formed as a plurality of 8-shaped coils each having a predetermined number of turns, wherein a first coil portion of the 8-shaped coil including overlapped winding wires is inserted into one slot, a second coil portion positioned opposed to the first coil portion in the circumference direction of the stator with respect to each ring constituting the 8-shape is inserted into another slot, the second coil portion not including overlapped winding wires, and wherein the two or more 8-shaped coils are positioned at a predetermined position of the stator with respect to each phase.

In a preferred embodiment, the first and second coil portions of each of the 8-shaped coils are positioned in respective slots so as to be displaced from each other by a slot pitch X, the slot pitch X corresponding to a quotient obtained by dividing the number of slots 6N by the number of poles 2P.

In a preferred embodiment, the 8-shaped coils are connected to each other by jumper wires with respect to respective three-phases of the motor.

In a preferred embodiment, each of the 8-shaped coils has two first coil portions and two second coil portions.

In a preferred embodiment, each of the 8-shaped coils has two first coil portions and one second coil portion.

In a preferred embodiment, the number of pairs of poles P is five and the number of slots 6N is twelve.

In a preferred embodiment, the number of pairs of poles P is five and the number of slots 6N is thirty-six.

Another aspect of the present invention provides a method of manufacturing a three-phase alternating-current motor comprising: a rotor having a plurality of pairs of poles; a stator positioned opposed to the rotor in a radial direction, the stator having a plurality of slots aligned in a circumference direction and extending in a rotational direction of the rotor; the and a plurality of winding wires inserted into the slots and wound on the stator, the method comprising the steps of: a. positioning a plurality of bobbins formed from insulating material so that the bobbins are separated from each other by a predetermined distance, each bobbin being configured to be attached to the stator so that each bobbin covers one teeth of the stator; b. winding a wiring material around the bobbins by a predetermined number of turns so as to form a coil; c. forming an 8-shaped coil by rotating at least one of the bobbins by 180 degrees around which the wiring material is wound; d. simultaneously inserting the bobbins around which the 8-shaped coil is wound into the tooth of the stator over three or more slots; and e. repeating steps a. to d. more than once so as to constitute a predetermined winding arrangement on the stator.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 is a cross-sectional view of a schematic configuration of an electric motor having ten poles and thirty-six slots;

FIG. 2 is a developed sectional view of a two-layer winding arrangement of the electric motor having ten poles and thirty-six slots;

FIG. 3 is a developed sectional view of a two-layer winding arrangement of an electric motor having ten poles and twelve slots;

FIG. 4a shows a coil having a simple annular shape;

FIG. 4b shows an 8-shaped coil formed by twisting the annular coil;

FIG. 4c shows a state in which the 8-shaped coil is inserted into a slot of a stator of an electric motor;

FIG. 5 is a developed sectional view of a winding arrangement of a three-phase alternating-current motor having ten poles and twelve slots, and shows an example in which the present invention is applied to the winding arrangement;

FIG. 6a shows a state in which a winding wire is wound around two bobbins;

FIG. 6b shows a state in which one of the bobbins is rotated by 180 degrees so as to form an 8-shaped wave-winding coil;

FIG. 6c shows a motion for simultaneously inserting the two bobbins into a core of the stator;

FIG. 6d shows a state in which the 8-shaped wave-winding coil is inserted into three slots;

FIG. 7 is a developed sectional view of a two-layer winding arrangement of a three-phase alternating-current motor having ten poles and thirty-six slots, and shows an example in which the present invention is applied to the winding arrangement, an example in which the 8-shaped coil is inserted into the slot, and a comparative example in which a conventional annular coil is inserted into the slot;

FIG. 8 is a developed sectional view of a three-layer winding arrangement of a three-phase alternating-current motor having ten poles and thirty-six slots, and shows an example in which the present invention is applied to the winding arrangement;

FIG. 9 shows an example of a configuration of the 8-shaped coil capable of being applied to the winding arrangement of FIG. 8;

FIG. 10 explains a method for manufacturing the 8-shaped coil of FIG. 9;

FIG. 11 shows another example of the configuration of the 8-shaped coil capable of being applied to the winding arrangement of FIG. 8;

FIG. 12a explains the method for manufacturing the 8-shaped coil of FIG. 11, in which a wave-winding coil having three rings is formed; and

FIG. 12b explains a state in which one of the three rings is turned-back so as to form the 8-shaped coil of FIG. 11.

### DETAILED DESCRIPTION

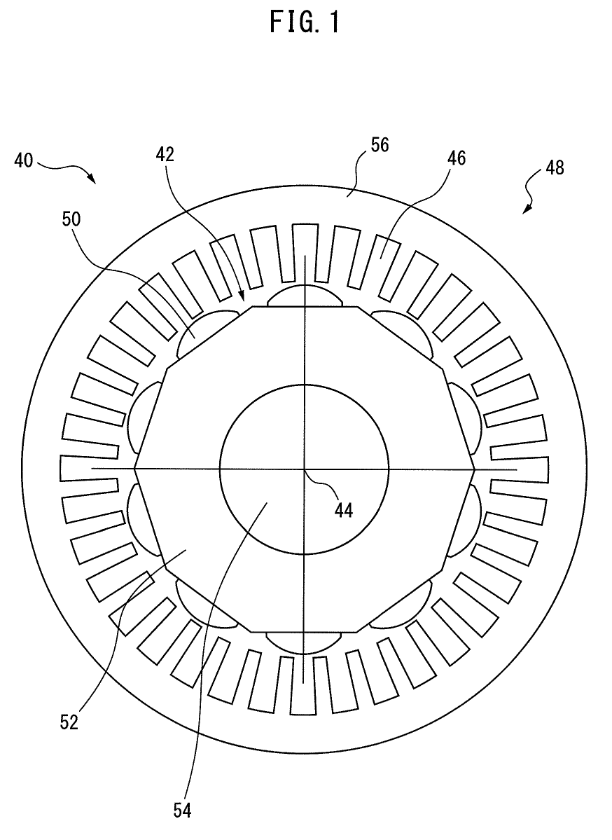

FIG. 1 is a radial cross-sectional view of a schematic configuration of an electric motor 40 according to a preferred embodiment of the present invention. Electric motor 40 as illustrated is a three-phase alternating-current motor having ten poles and thirty-six slots, and includes: a rotor 42 having a plurality of pairs of poles; a stator 48 positioned opposed to rotor 42 in a radial direction, having a plurality of slots 46 aligned in a circumference direction, and extending in a direction of a rotation axis 44 of rotor 42; and a plurality of winding wires inserted into slots 46 and wound on stator 48, as described below. In this motor, a value obtained by dividing the number of slots 6N (6N=36 in this case), into which the winding wires of stator 48 are inserted, by the number of pairs of poles P of rotor 42 (P=5 in this case) corresponds to an irreducible fraction, and a denominator of the fraction is two or more.

Rotor 42 has ten (permanent) magnets 50, a rotor core 52 and a rotor shaft 54, and is configured to rotate about rotation axis 44. The number of poles 2P is equal to ten, corresponding to the number of magnets 50. Since the present invention mainly relates to the winding wire (or a coil) inserted into slot 46 formed on stator core 56 of stator 48, an explanation of rotor 42 will be omitted in the following description.

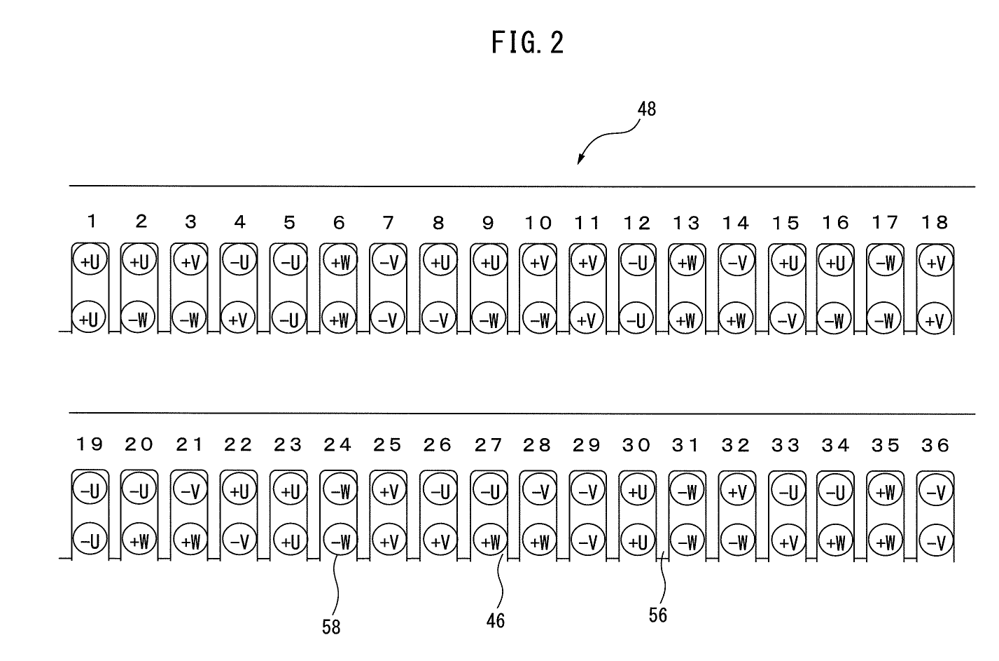

FIG. 2 is a developed sectional view of a two-layer winding arrangement of the 10-pole and 36-slot motor (i.e., the fractional-slot winding motor having ten poles and thirty-six slots, in which two layers of windings 58 are arranged in each slot 46). In FIG. 2, numerals (1 to 36) added to each slot 46 represent slot identify numbers. Although stator 48 has a cylindrical shape, cylindrical stator 48 is illustrated as the linearly developed sectional view for facilitating an explanation thereof.

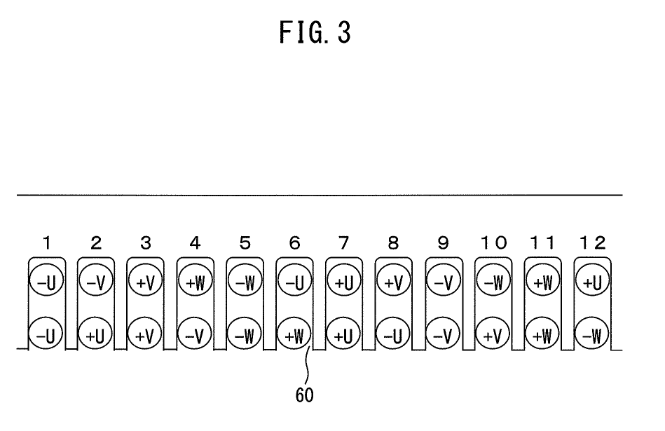

As another example to which the present invention can be applied, FIG. 3 shows a developed sectional view of a winding arrangement of the 10-pole and 12-slot motor (or the fractional-slot motor). In FIG. 3, numerals (1 to 12) added to each slot 60 represent slot identify numbers, similarly to FIG. 2.

In FIGS. 2 and 3, characters “U,” “V” and “W” represent respective phases of the three-phase alternating-current, and characters “+” and “−” represent respective directions of the current. The examples of FIGS. 2 and 3 relates to the two-layer winding, in which two phases among the six phases (i.e., +U, −U, +V, −V, +W and −W) are arranged in each slot. In each slot, the same number of a wiring material, such as a copper wire through which the current flows, is inserted.

Herein, the wiring material or a bundle of the wiring materials, such as the copper wire through which the current flows, is referred to as the “winding wire.” Further, a closed ring shape (including also an 8-shape as described below) is formed by the wiring material, and a bundle formed by the ring shapes having the same shape is referred to as the “coil.”

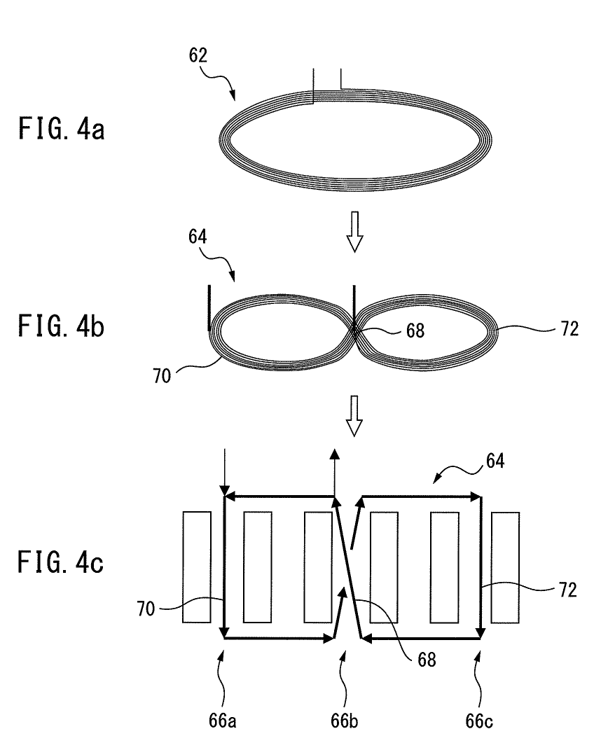

FIGS. 4a to 4c explain a structural example of an 8-shaped wave-winding coil according to the present invention. By twisting a portion of one annular coil 62 as shown in FIG. 4a, an 8-shaped coil 64 is formed as shown in FIG. 4b, and then, coil 64 is inserted and positioned in three slots 66a, 66b and 66c, as exemplified in FIG. 4c. Concretely, a first coil portion 68 of 8-shaped coil 64 including two overlapped edges (or winding wires) is inserted into center slot 66b, and other two edges (i.e., second coil portions 70 and 72 positioned opposed to first coil portion 68 in the circumference direction of the stator with respect to each ring constituting the 8-shape) are respectively inserted into slots 66a and 66c at the both sides of center slot 66b, in which each second coil portion does not include overlapped winding wires.

In this regard, when all of the 8-shaped coils are positioned on the stator so as to be displaced from each other by a slot pitch X (concretely, first coil portion 68 and second coil portions 70, 72 of each of the 8-shaped coils are positioned in respective slots so as to be displaced from each other by slot pitch X), the winding arrangements as shown in FIGS. 2 and 3 can be formed by the 8-shaped coils only, wherein the slot pitch X corresponds to a quotient obtained by dividing the number of slots 6N by the number of poles 2P. FIG. 4c exemplifies a case in which slot pitch X is equal to two, and each arrow in FIG. 4c represents a flow direction of the current in the coil. Further, since the shape of coil 64 represents a wave-winding as shown in FIG. 4b, such a coil may be also referred to as the “8-shaped wave-winding coil” herein.

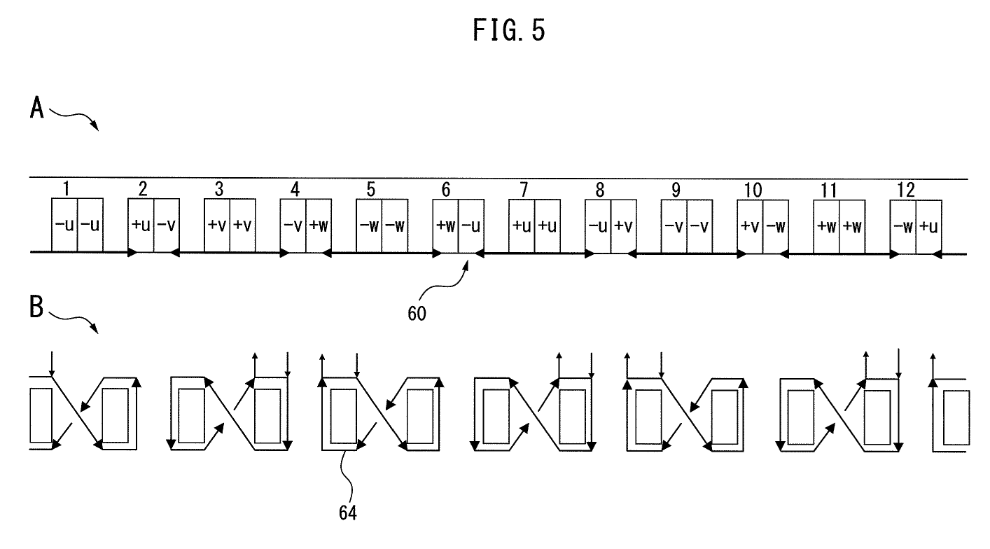

Section “A” of FIG. 5 shows a single-layer winding arrangement of a three-phase alternating-current motor having ten poles and twelve slots, and section “B” of FIG. 5 shows an example in which the present invention is applied to the winding arrangement of section A of FIG. 5. As shown in section B of FIG. 5, six 8-shaped coils 64 are inserted into respective slots 60 by a slot pitch equal to one.

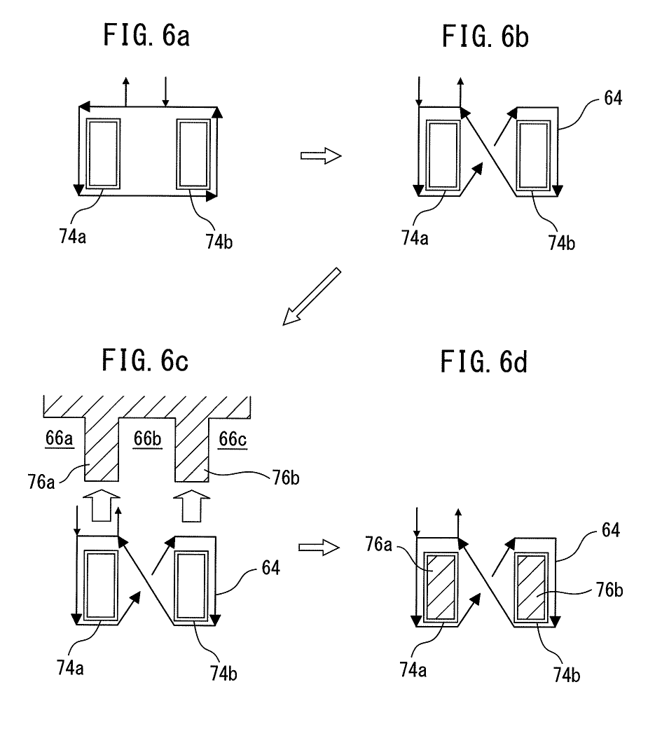

FIGS. 6a to 6d explain an example of a method for manufacturing the stator of the electric motor of the present invention, concretely, an example of a procedure for inserting each coil 64 into slot 60. First, as shown in FIG. 6a, a plurality of (in the illustrated embodiment, two) bobbins 74a and 74b, formed from insulating material, are positioned so as to be separated from each other by a predetermined distance, and a wiring material is wound around the bobbins by a predetermined number of turns. Then, as shown in FIG. 6b, by twisting (or rotating) one of the bobbins (in this case, bobbin 74b) by 180 degrees, 8-shaped wave-winding coil 64 is manufactured.

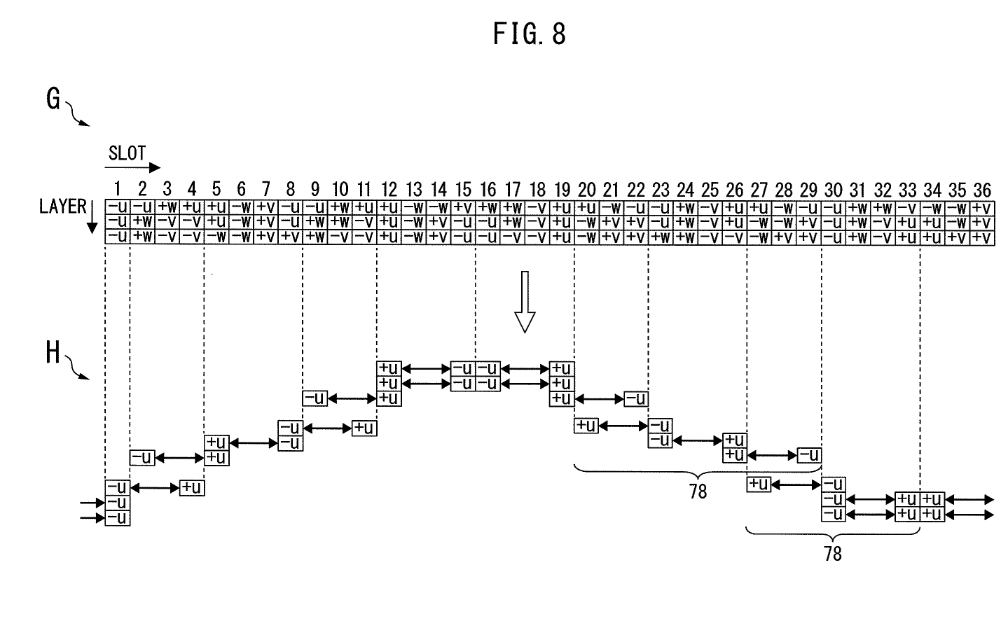

Next, as shown in FIG. 6c, from the stated of FIG. 6b, two bobbins 74a and 74b are simultaneously inserted into a stator core (concretely, two tooth 76a and 76b of the stator core) while keeping the positional relationship between the bobbins, whereby coil 64 is positioned in three slots 66a, 66b and 66c. Since each bobbin is configured to attached to and cover one of the tooth of the stator, by operations of FIGS. 6a to 6c, 8-shaped wave-winding coil 64 can be inserted over three slots, as shown in FIG. 6d. By repeating operations of FIGS. 6a to 6d several times (in this example, six times), the winding arrangement as shown in FIG. 5 can be obtained.

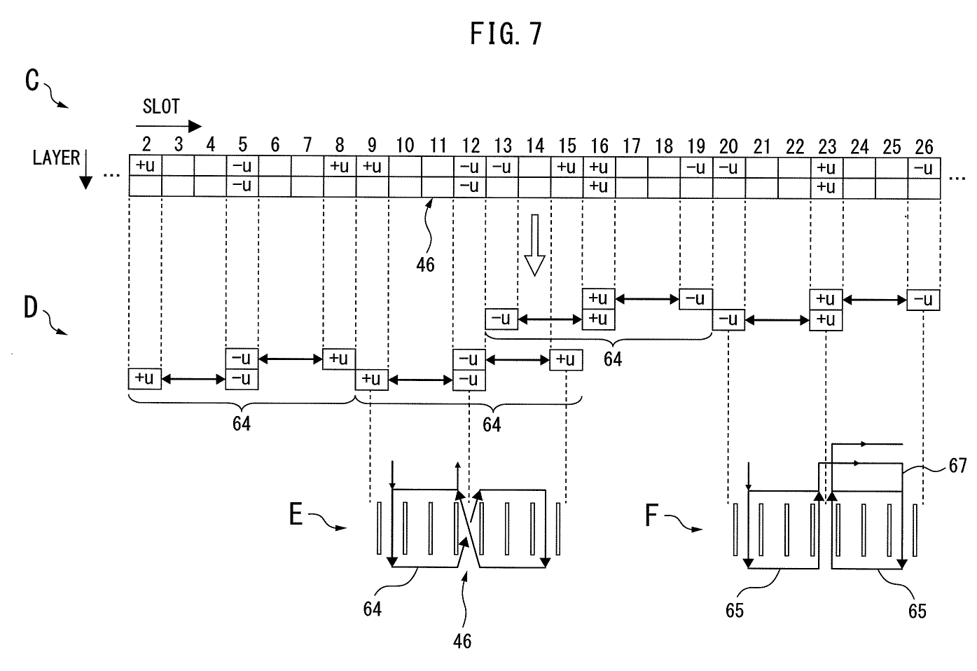

Section “C” of FIG. 7 shows a two-layer winding arrangement of a three-phase alternating-current motor having ten poles and thirty-six slots, and section “D” of FIG. 7 shows an example in which the present invention is applied to the winding arrangement of section C of FIG. 7. Six 8-shaped coils 64 as shown in FIG. 4b are inserted into respective slots 46 by a slot pitch equal to three. For the sake of clarity, in FIG. 7, only the U-phases of the twenty-five slots among the thirty-six slots are indicated, and coil 64 is illustrated as four developed views.

As shown in section D of FIG. 7, the winding arrangement in section C of FIG. 7 can be totally developed by the coils positioned by the slot pitch corresponding to three. In the prior art, like a comparative example as shown in section “F” of FIG. 7, two annular coils 65 are positioned in respective three slots while one slot is common to the two coils. Therefore, it is necessary to arrange a jumper wire 67 for connecting two coils 65.

On the other hand, in the present invention, as shown in section “E” of FIG. 7, two coils 65 can be replaced with one 8-shaped coil 64. Further, the six 8-shaped coils are necessary for each phase, and thus eighteen 8-shaped coils are sufficient for the three-phase electric motor. Therefore, in this embodiment, unlike the complicated winding arrangement in the prior art, the entirety of the winding arrangement can be constituted by preparing a plurality of coil units having the same shape, whereby (the stator of) the electric motor can be easily manufactured. Further, in this embodiment, although it is necessary to connect each phase in series between each coil by using a jumper wire, it is not necessary to use jumper wire 67 as shown in section “F” of FIG. 7. Therefore, the number of the jumper wires can be reduced in the embodiment, and the jumper wires are less likely to be intricately intertwined with each other.

Section “G” of FIG. 8 is a developed sectional view of a three-layer winding arrangement of a three-phase alternating-current motor having ten poles and thirty-six slots, to which the present invention can be applied. In this example, the winding arrangement is constituted by two types of 8-shaped wave-winding coils 78 and 84 as described below, as shown in section “H” of FIG. 8 which indicates the winding arrangement with respect to the U-phase only.

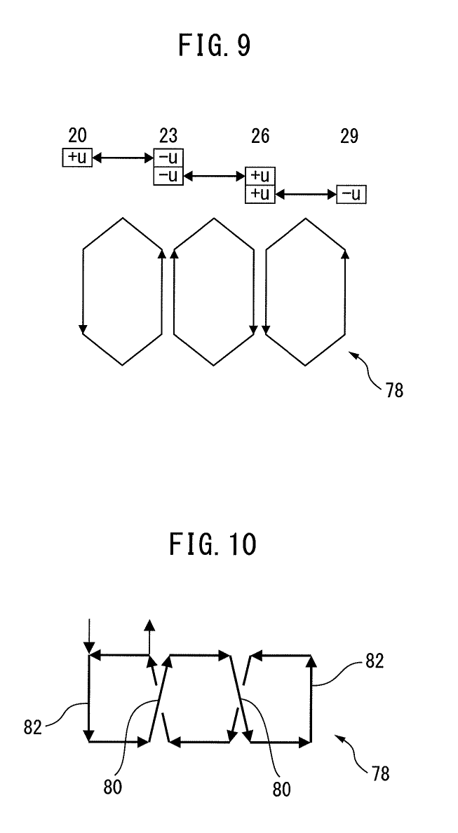

FIG. 9 shows a structural example of 8-shaped wave-winding coil 78 positioned over four slots in FIG. 8 by a slot pitch equal to three which corresponds to a quotient obtained by dividing the number of slots (=36) by the number of poles (=10), and FIG. 10 explains a method for manufacturing coil 78. Coil 78 can be manufactured by using three bobbins as explained with reference to FIGS. 6a to 6d. Concretely, the three bobbins are positioned so as to be separated from each other by a predetermined distance, and a wiring material is wound around the bobbins by a predetermined number of turns. Then, by twisting (or rotating) at least one bobbin by 180 degrees twice (for example, by rotating the left bobbin by 180 degrees, and rotating the right bobbin by 180 degrees), 8-shaped wave-winding coil 78 is manufactured. As shown in FIG. 10, coil 78 has two first coil portions 80 each including two overlapped edges (or winding wires), and two second coil portions 82 positioned opposed to respective first coil portions 80 in the circumference direction of the stator, in which each second coil portion does not include overlapped winding wires.

Then, similarly to the example of FIG. 6c, the three bobbins are simultaneously inserted into the stator core while keeping the positional relationship between the bobbins, whereby (first coil portions 80 and second coil portions 82 of) coil 78 is (are) positioned in four slots (in the example of FIG. 9, slots 20, 23, 26 and 29).

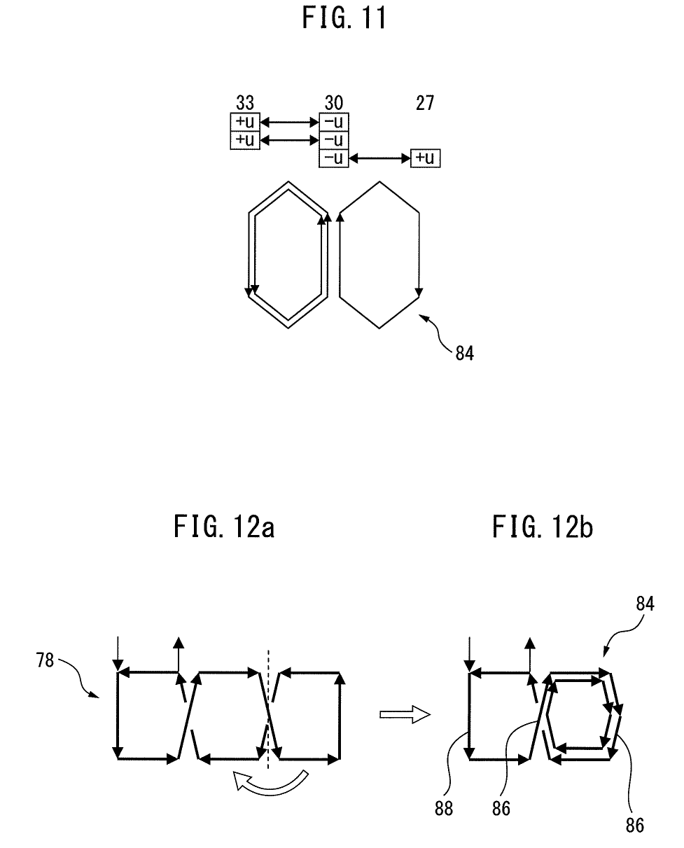

FIG. 11 shows a structural example of 8-shaped wave-winding coil 84 positioned over three slots in FIG. 8 by a slot pitch equal to three which corresponds to a quotient obtained by dividing the number of slots (=36) by the number of poles (=10), and FIGS. 12a and 12b explains a method for manufacturing coil 82. First, as shown in FIG. 12a, coil 78 having three loops is formed by a method similar to the method of FIG. 10, and then one of the three loops (in the illustrated example, the right loop) is turned-back (along a dashed line in FIG. 12a) so as to be overlapped with the center loop, whereby 8-shaped wave-winding coil 84 as shown in FIG. 12b is obtained. Concretely, coil 84 has two first coil portions 86 each including two overlapped edges (or winding wires), and one second coil portion 88 positioned opposed to first coil portion 86 in the circumference direction of the stator, in which the second coil portion does not include overlapped winding wires. As such, (first coil portions 86 and second coil portion 88 of) coil 84 is (are) positioned in three slots (in the example of FIG. 11, slots 27, 30 and 33).

A coil having three or more loops formed by a substantially continuous winding wire, such as coil 78 as shown in FIG. 9 or 10 having three loops, partially includes the 8-shape. Also, a coil having three or more loops such as coil 84 as shown in FIG. 11, 12a or 12b, in which at least one loop is turned-back so as to overlap with another loop so that the number of loops is substantially reduced, includes the 8-shape. Therefore, these coils may also be referred to as the 8-shaped wave-winding coils.

As described above, the winding arrangement as shown in FIG. 8 includes two types of coils 78 and 84, and coils 78 and 84 can be manufactured from the winding wire having the same dimension. Therefore, the process indicated by FIG. 12a is common to the manufacturing processes of coils 78 and 84, and thus the man-hours for manufacturing the stator can be reduced.

In any of the above embodiments, it is not necessary to arrange a jumper wire between the loops constituting the 8-shape of each coil. Therefore, the stator of the electric motor can be constituted by using less jumper wires than the prior art. In this regard, each of the 8-shaped coils is connected to each other in series by the jumper wire with respect to each of the three phases, and the plurality of 8-shaped coils are positioned at predetermined positions on the stator with respect to each phase.

According to the present invention, in the electric motor including the fractional slot having the complicated winding arrangement, the number of coils and the man-hours for manufacturing the electric motor can be reduced by using the 8-shaped coil. Further, the number of jumper wires for connecting the coils can also be reduced, and thus the probability that the jumper wires are intricately intertwined with each other can be significantly reduced.

While the invention has been described with reference to specific embodiments chosen for the purpose of illustration, it should be apparent that numerous modifications could be made thereto, by one skilled in the art, without departing from the basic concept and scope of the invention.

1. A three-phase alternating-current motor, comprising:
a rotor having a plurality of pairs of poles;
a stator positioned opposed to the rotor in a radial direction, the stator having a plurality of slots aligned in a circumference direction and extending in a rotational direction of the rotor; and
a plurality of winding wires inserted into the slots and wound on the stator,
wherein the rotor has P pairs of poles and 6N slots where the winding wires of the stator are inserted, the number of slots 6N divided by the number of pairs of poles P corresponds to an irreducible fraction, and a denominator of the fraction is two or more;
wherein the winding wires are positioned in the slots so that the winding wires are formed as a plurality of 8-shaped coils each having a predetermined number of turns,
wherein a first coil portion of the 8-shaped coil including overlapped winding wires is inserted into one slot, a second coil portion positioned opposed to the first coil portion in the circumference direction of the stator with respect to each ring constituting the 8-shape is inserted into another slot, the second coil portion not including overlapped winding wires, and
wherein the two or more 8-shaped coils are positioned at a predetermined position of the stator with respect to each phase.

2. The three-phase alternating-current motor as set forth in claim 1, wherein the first and second coil portions of each of the 8-shaped coils are positioned in respective slots so as to be displaced from each other by a slot pitch X, the slot pitch X corresponding to a quotient obtained by dividing the number of slots 6N by the number of poles 2P.

3. The three-phase alternating-current motor as set forth in claim 1, wherein the 8-shaped coils are connected to each other by jumper wires with respect to respective three-phases of the motor.

4. The three-phase alternating-current motor as set forth in claim 1, wherein each of the 8-shaped coils has two first coil portions and two second coil portions.

5. The three-phase alternating-current motor as set forth in claim 1, wherein each of the 8-shaped coils has two first coil portions and one second coil portion.

6. The three-phase alternating-current motor as set forth in claim 1, wherein the number of pairs of poles P is five and the number of slots 6N is twelve.

7. The three-phase alternating-current motor as set forth in claim 1, wherein the number of pairs of poles P is five and the number of slots 6N is thirty-six.

8. A method of manufacturing a three-phase alternating-current motor comprising:
a rotor having a plurality of pairs of poles;
a stator positioned opposed to the rotor in a radial direction, the stator having a plurality of slots aligned in a circumference direction and extending in a rotational direction of the rotor; the and
a plurality of winding wires inserted into the slots and wound on the stator, the method comprising the steps of:
a. positioning a plurality of bobbins formed from insulating material so that the bobbins are separated from each other by a predetermined distance, each bobbin being configured to be attached to the stator so that each bobbin covers one teeth of the stator;
b. winding a wiring material around the bobbins by a predetermined number of turns so as to form a coil;
c. forming an 8-shaped coil by rotating at least one of the bobbins by 180 degrees around which the wiring material is wound;
d. simultaneously inserting the bobbins around which the 8-shaped coil is wound into the tooth of the stator over three or more slots; and
e. repeating steps a. to d. more than once so as to constitute a predetermined winding arrangement on the stator.
